(19) United States
(12) Patent Application Publication
(10) Pub. No.: US 2013/0251870 A1
(43) Pub. Date: Sep. 26, 2013

(54) DEVICES AND METHODS FOR DEHULLING BEANS AND MAKING SOYMILK

(71) Applicants: Qi Zhou, Eindhoven (NL); Chang Jie Wang, Eindhoven (NL); Donghai Yu, Eindhoven (NL)

(72) Inventors: Qi Zhou, Eindhoven (NL); Chang Jie Wang, Eindhoven (NL); Donghai Yu, Eindhoven (NL)

(73) Assignee: KONINKLIJKE PHILIPS ELECTRONICS N.V., EINDHOVEN (NL)

(21) Appl. No.: 13/990,044

(22) PCT Filed: Nov. 30, 2011
(86) PCT No.: PCT/IB2011/055390

§ 371 Date: May 29, 2013

(30) Foreign Application Priority Data
Dec. 8, 2010 (CN) CN2010/001990

(51) Int. Cl. A23N 15/10; A23C 11/10

(52) U.S. Cl. CPC A23N 15/10; A23C 11/103
USPC 426/482; 99/518

(57) ABSTRACT

The present invention discloses a device for dehulling beans, a method of dehulling beans, an apparatus for making soymilk and a method of making soymilk. The device for dehulling beans may comprise a driving motor (110); a controller (120) electrically coupled to the driving motor (110) for controlling the driving motor; and a first unit (130) coupled to and driven by the driving motor (110) to stir the beans soaked in water so as to generate a mixture containing hulls and dehulled beans. With the present invention, the beans can be dehulled before the blending process for soymilk making, so the size of particles contained in the soymilk and hence the quantity of the residue is substantially reduced.

### FIELD OF THE INVENTION

The present invention generally relates to processing beans, and particularly to a device for dehulling beans, a method of dehulling beans, an apparatus for making soymilk and a method of making soymilk.

### BACKGROUND OF THE INVENTION

Soymilk makers, particularly household soymilk makers, are becoming more and more popular nowadays. Conventionally, the soymilk making process basically includes three phases. The first phase is a soaking phase done manually by users, wherein dry beans are usually put into for example a bowl of water and kept at room temperature overnight. Subsequently, the process proceeds to the second phase, i.e., a blending/cooking phase, automatically controlled by a controller, wherein the soaked beans and water put into a main body of the soymilk maker are boiled for about 1 to 10 minutes by means of the heating means, and then a blender is driven to blend the soybeans into small particles. The third phase is a filtering phase done manually by users by means of a filter (50-mesh filter is commonly used), wherein the relatively big particles (also referred to as residue hereinafter) that cannot pass through the filter will be removed from the resultant fluid after the blending/cooking phase so as to obtain the refined soymilk. The resulting soymilk is a mixture of water and small particles of hulls and cotyledons.

However, there are some drawbacks in the conventional soymilk-making process as described above. After the second phase, i.e., the blending/cooking phase, the size of particles contained in the resultant fluid is still relatively large, and thus many particles will be filtered out, which results in a large quantity of residues.

Therefore, there is a need to further reduce the size of particles contained in the resultant fluid, thereby reducing the quantity of residues effectively.

### SUMMARY OF THE INVENTION

In view of the above, there is provided a solution to reduce the size of particles contained in the resultant fluid so as to reduce the quantity of residues effectively.

In a first aspect of the invention, there is provided a novel device for dehulling beans, comprising: a driving motor; a controller electrically coupled to the driving motor for controlling the driving motor; and a first unit coupled to and driven by the driving motor to stir the beans soaked in water so as to generate a mixture containing hulls and dehulled beans.

In an embodiment of the invention, the beans can be soaked in water for a period of time so that gaps are formed between the hulls and inner parts of the beans.

In another embodiment of the invention, the beans may be soybeans and the soybeans can be soaked in water at about 45□ to 90□ for about 5 to 15 minutes.

In a further embodiment of the invention, the first unit can have at least one blade or at least one stirring rod.

In a still further embodiment of the invention, the first unit has at least one blade, and the stirring speed for stirring the soaked beans may be lower than 1000 revolutions per minute (rpm). Additionally, in a further, preferable embodiment, the stirring speed is about 400 rpm.

In a yet further embodiment of the invention, the device for dehulling beans can further comprise a second unit for separating at least part of the hulls from the mixture containing the hulls and dehulled beans.

In a second aspect of the invention, there is provided an apparatus for making soymilk, comprising the device for dehulling beans as stated in the first aspect of the invention, wherein the controller is configured to further control the driving motor so that the first unit is driven to blend the mixture at a blending speed higher than the stirring speed so as to make soymilk.

In a third aspect of the invention, there is provided a method of dehulling beans, comprising: soaking the beans in water; and driving a first unit for stirring the soaked beans so as to generate a mixture containing hulls and dehulled beans.

In an embodiment of the invention, the beans can be soaked so that gaps are formed between the hulls and inner parts of the beans.

In another embodiment of the invention, the beans may be soybeans, and the soybeans can be soaked in water at about 45□ to 90□ for about 5 to 15 minutes.

In a further embodiment of the invention, the first unit for stirring the soaked beans can have at least one blade or at least one stirring rod.

In a still further embodiment of the invention, a stirring speed of the first unit having at least one blade may be lower than 1000 rpm.

In a yet further embodiment of the invention, the method can further comprise separating at least part of the hulls from the mixture.

In a fourth aspect of the invention, there is provided a method of making soymilk, comprising: dehulling beans according to the method of dehulling beans as stated in the third aspect of the invention, and blending, by the first unit, the mixture at a blending speed higher than the stirring speed so as to make soymilk.

In the present invention, a stirring/dehulling process is provided by which the beans will be dehulled. As a result, after the subsequent blending process, the particle size will be smaller and the amount of particles with a relatively large size will be less than in conventional soymilk-making processes. Particularly, in a preferable embodiment in which at least part of the hulls are removed from the resultant mixture after the dehulling process, the particles size and the quantity of relatively large particles are reduced more efficiently. Therefore, with the present invention, the size of particles contained in the soymilk and hence the quantity of the residue are substantially reduced.

These and other aspects of the invention will be apparent from and elucidated with reference to the embodiments described hereinafter.

### BRIEF DESCRIPTION OF THE DRAWINGS

The invention will now be described in more detail by way of example with reference to the accompanying drawings, in which:

FIG. 1 schematically illustrates a block diagram of a device for dehulling beans according to an embodiment of the invention;

FIG. 2 schematically illustrates a flowchart of a method of dehulling beans according to another embodiment of the invention;

FIG. 3 schematically illustrates a block diagram of an apparatus for making soymilk according to a further embodiment of the invention; and

FIG. 4 schematically illustrates a flowchart of a method of making soymilk according to a still further embodiment of the invention;

### DETAILED DESCRIPTION OF EMBODIMENTS

The term “inner parts of the beans” used herein is a generalized concept and with respect to soybeans, mung beans, cowpea, etc., the terms “inner parts of the beans”, “dehulled beans” and “cotyledon(s)” generally have a similar meaning.

The term “separation rate” used herein refers to a percentage of the hulls separated from the mixture containing the hulls and the cotyledons of the beans. The higher “dehulling rate” means that more hulls are separated from the mixture and more cotyledons of beans remain in the mixture.

Hereinafter, the invention will be described in more detail by way of example with reference to the accompanying drawings.

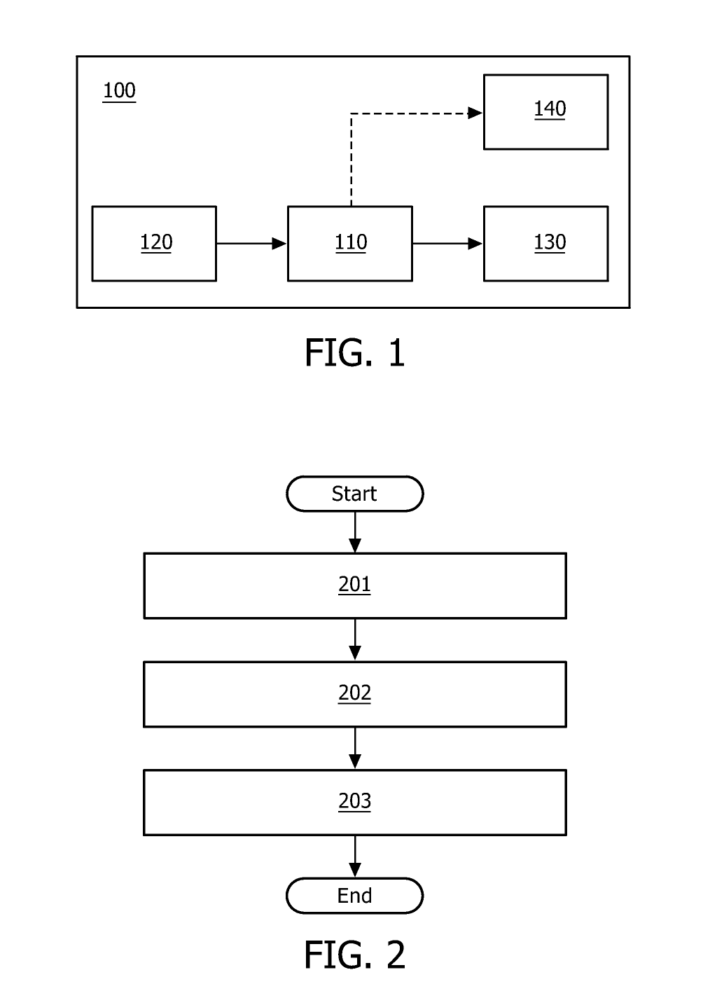

Reference will first be made to FIG. 1, which schematically illustrates a block diagram of a device for dehulling beans according to an embodiment of the invention.

As illustrated in FIG. 1, the device 100 for dehulling beans can comprise a driving motor 110, a controller 120 and a first unit 130. The controller 120 is electrically coupled to the driving motor 110 and configured for controlling the driving motor 110. The first unit 130 is coupled to the driving motor 110 and is driven by the driving motor 110 to stir the beans soaked in water so as to generate a mixture containing hulls and dehulled beans.

The controller 120 can be a microprocessor or any other control means which can be configured to control the operation of the driving motor 110, for example one or more of the power to the driving motor 110, the rotating speed of the driving motor 110, the time period for driving. The driving motor 110 is for example mechanically connected to the first unit 130 in any suitable manner known to those skilled in the art and will drive, under the control of the controller 120, the first unit 130 to rotate or move in any other manner so as to stir the beans soaked in the water.

In an embodiment of the present invention, the first unit 130 can be a blender including one or more blades, or alternatively it can also include one or more stirring rods for stirring the soaked beans. During operation of the first unit 130, it will strike against the soaked beans, causing the hulls to be stripped from the soaked beans. Additionally, the blender having one or more blades will facilitate the stripping of the hulls, because the blade having a sharp edge may contribute to said dehulling. It should be noted that the first unit 130 can also be implemented as any suitable means conceivable by those skilled in the art, provided the means can be driven by the driving motor 110 to stir the soaked beans.

According to the present invention, the beans soaked in water are stirred by the first unit 130 driven by the driving motor 110 controlled by the controller 120. It has been found that the hulls and the cotyledons of beans can have different absorption rates, i.e., different abilities with respect to water absorption. Generally, the hulls will have a higher absorption rate than the cotyledons. Therefore, when the beans are soaked in water, the hulls will absorb more water than the cotyledons, and subsequently expand and become soft; the cotyledons however will still remain relatively hard. Therefore, under the effect of a striking force created during stirring, the soft hulls will be separated from hard cotyledons. Thus, there is provided a possibility to strip the hulls from the soaked beans by stirring.

However, it is noted that the soaking time should be long enough to soften the hulls and at the same time short enough to substantially preserve the hardness of the cotyledons. On the one hand, if the soaking time is too short, the hulls will not absorb enough water and thus will remain hard. Consequently, it is difficult to dehull the beans. On the other hand, if the soaking time is too long, both the hulls and the cotyledons will absorb enough water to expand and become soft. In the latter case, the hulls and cotyledons tend to adhere together, as a result of which it is also hard to dehull the beans. It is noted that the soaking time is different for different types of beans, but it can be learned by experiments or tests, or in any other suitable manner known in the art. For example, as far as soybeans are concerned, 5 to 15 minutes are preferred. In addition, it is preferred that the beans are soaked in hot water for example at about 45-90□ so as to achieve a good effect at an acceptable soaking time. For the sake of clarity, details of various other types of beans will not be given here.

Preferably, the beans can be soaked in water so that gaps can be formed between hulls and cotyledons of the beans. Due to different absorption rates, the hulls will expand and become soft while the cotyledons still remain relatively hard and thus, after a certain time, gaps will be formed between hulls and cotyledons. If the gaps are formed between hulls and cotyledons shortly after the stirring operation has begun, this will further facilitate the stripping of the hulls from the cotyledons. The time that will pass before gaps are formed can be determined by for example experiments, tests or any other approaches for different types of beans, which can be conceived by those skilled in the art and will not be described in detail here for the sake of clarity.

Additionally, to dehull the beans, the speed of stirring the soaked beans (also referred to as the stirring speed hereinafter) must not be too high because at an excessively high speed, the hulls and the cotyledons will be blended together and even broken into particles, and the effect obtained by dehulling the beans through stirring will not be achieved. Generally, in a conventional soymilk-making process, the beans will be blended at a blending/cooking speed of 4000 to 19000 rpm or even higher so as to make soymilk. At such a high speed, the beans are blended into small particles and the resultant fluid will contain particles of the hulls and the cotyledons. Thus, the hulls cannot be stripped from the beans in such cases. To this end, the stirring speed should be lower than a blending/cooking speed as commonly used in the conventional soymilk maker to prevent blending of the beans to particles, and it is preferred that the stirring speed is substantially lower than the blending/cooking speed. It is noted that, for different types of beans, different soaking times or any other factors, it is possible to set different stirring speeds to achieve a high efficiency. The stirring speed for various conditions can be determined by experiments or tests, or in any other suitable manner well known in the art. For example, a stirring speed lower than 1000 rpm is generally preferred in the case that the first unit comprises one or more blades, and more preferably, the stirring speed can be set at about 400 rpm. At such stirring speeds, the beans can be dehulled efficiently. For the sake of clarity, a detailed description with regard to various conditions will not be given here.

In accordance with an embodiment of the invention, the beans may be soybeans, and the soybeans can be soaked in water at about 45-90□ for about 5-15 minutes. In such cases, more gaps will be formed due to a different absorption rate between the hulls and the cotyledons of the beans. For example, the water temperature can be set at about 45□, and the soaking time can be set at about 15 minutes. Preferably, the water temperature can be set at about 60□, and the soaking time can be set at about 13 minutes. More preferably, the water temperature can be set at about 75□, and the soaking time can be set at about 10 minutes. Most preferably, the water temperature can be set at about 90□, and the soaking time can be set at about 5 minutes.

From the embodiments described above, it can be seen that the higher the water temperature, the shorter the soaking time can be. Under the condition that water of 90□ is used, it will take the shortest soaking time, i.e., about 5 minutes, to obtain the well-soaked beans in the sense of the present invention. Hence, a time reduction will be achieved, which is desirable.

It should be noted that the stirring speed can be set to a much lower value than the blending/cooking speed in the present stirring/dehulling phase, and thus after this phase, the beans will be dehulled, or in other words the hulls are stripped from the beans. Therefore, at the end of the stirring operation, a mixture will be achieved containing the stripped hulls and the cotyledons, and said stripped hulls and the cotyledons are basically kept in the form of relatively large realistic objects which have not broken into particles.

In another embodiment of the present invention, the device 100 can preferably comprise a second unit 140 which is configured for separating at least part of the hulls from the resultant mixture. The second unit 140 can be a vacuum device fixed to or detachable from the device 100 or a separate vacuum device which could suck up the hulls. The second unit can also be driven by the driving motor 110, or alternatively by another driving means separated from the driving motor 110. It is well known to those skilled in the art that the hulls are lighter than the cotyledons, so the hulls tend to float on the water and the cotyledons tend to settle in the water after the stirring/dehulling phase. By means of such a vacuum device, the lighter hulls floating on the water can be sucked up so as to remove them from the mixture, whereas the relatively heavier cotyledons will be left in the water. It should be noted that the sucking power of the vacuum device should be high enough to suck up the hulls and, at the same time, it should be low enough to leave the heavier cotyledons in the water. The specific level of the power can be determined through experiments, tests or any other suitable approach, which is known to those skilled in the art and will not be described in more detail herein for the sake of clarity.

In such a way, the quantity of hulls that remain in the mixture will be reduced substantially and the mixture used for making soymilk will contain fewer hulls and thus, after the subsequent blending/cooking phase, the resulting fluid will contain much smaller particles. Therefore, the soymilk will be finer and smoother.

Additionally, it is preferred that the user is provided with an option to set the quantity of hulls contained in the mixture after the separation process in order to meet various requirements of the user. If the user wants a higher protein yield, fewer hulls should be left in the mixture, since the cotyledons commonly contain more protein components than the hulls. This means that more hulls need to be filtered out of the mixture. On the other hand, if the user desires a higher fiber intake, more hulls should be left in the mixture. Such an option enables various requirements of the user to be met.

Alternatively, the second unit 140 can be a hull filter which is to be, preferably detachably, connected to the device 100. The hull filter can be arranged for example at the inner wall of the container for receiving the mixture and slightly above the still water surface so as to collect the floating hulls. During the stirring/dehulling phase, the blades or stirring rods of the first unit 130 will rotate and a water vortex rapidly rotating inside the container will be created. Accordingly, the water level near the inner wall will rise, and the relatively lighter hulls floating on the water surface tend to be pushed towards the inner wall under the influence of the centrifugal force and will be collected by the arranged hull filter. Additionally, it can also be understood that the hull filter can be a filter mesh which can be used by the user to separate the hulls manually.

It should be noted that the second device 140 is optional. It is known that soybean hulls contain around 80% fibres, which is beneficial for health. Thus, if the user desires maximum fibre intake, he will have no need for the second device for performing the separating process.

Moreover, the person skilled in the art can understand that the present invention can be used to dehull different types of beans, such as soybeans, mung beans, cowpea, etc. For different types of beans, the suitable configuration, such as the water temperature, the soaking time, the stirring speed and the like, is different. However, the configuration can be determined by those skilled in the art, under the teaching of the present invention, through experiments, tests or any other approach which is known in the art and which therefore will not be described in detail herein.

Hereinafter, a method of dehulling beans according to the invention will be described with reference to FIG. 2 which schematically illustrates a flowchart of a method of dehulling beans according to another embodiment of the invention.

As shown in FIG. 2, at step 201, the beans are soaked in water. As described hereinbefore, the soybeans can be soaked in water at about 45-90□ for about 5-15 minutes. After said time period, the hulls will expand and become soft whereas the cotyledons still substantially preserve their hardness. Therefore, the soaked beans in such a condition will facilitate the following dehulling operation. Preferably, the beans can be soaked so that gaps are formed between hulls and inner parts of the beans. The soaked beans having gaps inside will further facilitate the dehulling operation.

At step 202 the soaked beans are stirred so as to generate a mixture containing hulls and dehulled beans. When the soaked beans are ready, the dehulling operation may start. The first unit 140, which can comprise at least one blade or at least one stirring rod, will be driven by for example the driving motor 110 under the control of the controller 120. As described hereinabove, the first unit can be rotated at a stirring speed lower, preferably substantially lower, than the normal blending/cooking speed. Preferably, in the case that the first unit has at least one blade, i.e., it is a blender, the stirring speed is lower than 1000 rpm, and more preferably, the stirring speed is set to 400 rpm. As stated above, the hulls will be stripped from the beans after the stirring/dehulling phase, and the resultant mixture will contain the hulls and the dehulled beans.

Preferably, in step 203, at least part of the hulls is separated from the mixture. As stated above, the separation operation can be performed by a second unit 140 which can be a vacuum device or a filter. As a result of the optional separation operation, the quantity of hulls remaining in the mixture will be reduced substantially and the mixture for the subsequent making of soymilk will contain fewer hulls. Therefore, after the subsequent blending/cooking phase, the resulting fluid will contain much smaller particles, and the soymilk will be finer and smoother.

It is noted that the stirring/dehulling process will be performed prior to the blending/cooking process, and hence the stirring/dehulling process can also be referred to as a pre-blending process. With the device and method for dehulling the beans, the hulls of the beans will be stripped from the beans and the subsequent blending/cooking process will be facilitated.

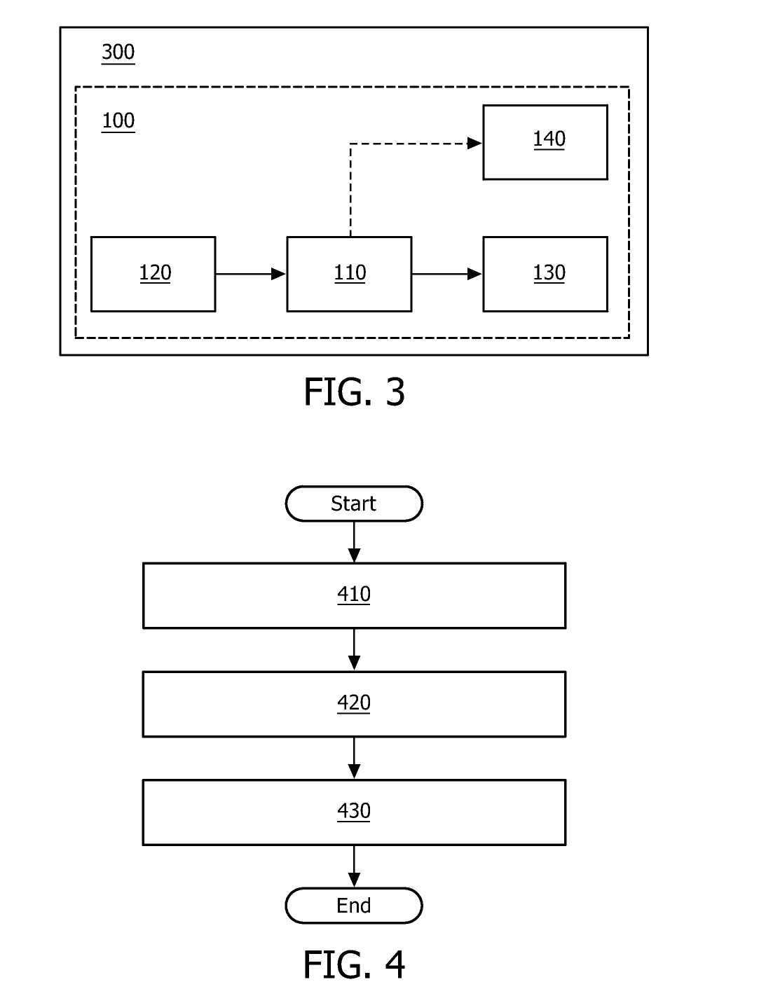

Next, reference will be made to FIG. 3 which schematically illustrates a block diagram of an apparatus for making soymilk according to a further embodiment of the invention. As shown in FIG. 3, the apparatus 300 comprises the device 100 for dehulling beans for example as shown in FIG. 1. Moreover, the controller 120 is configured to further control the driving motor 110 so that the first unit 130 is driven to blend the mixture so as to make soymilk. The blending speed can be set at about 4000 to 19000 rpm, which is higher than the stirring speed. Those skilled in the art will understand that the device 100 can be integrated with the apparatus 300 or it can be a standalone accessory device thereof.

Additionally, FIG. 4 also schematically illustrates a flowchart of a method of making soymilk according to a still further embodiment of the invention. As shown in FIG. 4, at step 410, the beans are dehulled in accordance with operations as described with reference to FIG. 2. In this step, the first unit 130 having for example stirring rods or blades will first stir the beans soaked in water at a lower stirring speed (for example less than 1000 rpm) and dehull the beans substantially without damaging or breaking up the cotyledons, thereby generating the mixture containing hulls and dehulled beans.

After that, the method proceeds to the blending/cooking phase, i.e., step 420, during which the mixture generated after dehulling will be blended at a blending speed of, for example, 10000 rpm, which is higher than the stirring speed. In the blending process, the mixture will be blended thoroughly and the resultant fluid, i.e., the soymilk, will have particles of a very small size as compared to the conventional process.

However, if the user desires, at step 430, the soymilk can be further filtered by a filter such as a 50-mesh filter so as to filter out the relatively large particles.

In the conventional soymilk-making process, the blending speed during the whole process is basically constant, that is to say, it only comprises a blending process. The present invention however introduces an additional process of dehulling beans prior to the blending/cooking phase. With the present invention, after the blending process, the size of the particles contained in the fluid will be smaller than that of the prior art. Moreover, in the case that the separation process is performed, the cotyledons of the beans will be broken into very small pieces in the subsequent blending/cooking phase, thereby achieving a better particle size distribution throughout the resultant soymilk before performing the filtering operation. Therefore, with the present invention, the quantity of residues can be substantially reduced.

Table 1 shows a particle size distribution of soymilk made from dehulled and non-dehulled soybeans, which is the result of the comparison experiments performed by the inventor.

TABLE 1

| | Particle Size Distribution | |
|---|---|---|
| Grinding | Dehulled samples | Non-dehulled samples |

| times | Particle | Volume | Particle Size | Volume |
|---|---|---|---|---|
| (*20 s) | Size (μm) | (%) | (μm) | (%) |
| 1 | 715.516 | D(90) | 1093.972 | D(90) |
| 4 | 517.949 | D(90) | 716.426 | D(90) |
| 6 | 432.911 | D(90) | 644.837 | D(90) |
| 8 | 309.013 | D(90) | 607.500 | D(90) |
| 12 | 289.622 | D(90) | 479.488 | D(90) |

The parameters used in the experiments are as follows:

| | |
|---|---|
| raw material | soybeans |
| water temperature | 90□; |
| soaking time | 5 minutes; |
| beans(weight)/water(volume) | 70 g/900 ml |
| stirring speed | 400 rpm; |
| blending speed | 10000 rpm; and |
| dehulling rate | 100% |
| measurement time | after the blending/cooking phase but just |
| | before the filtering phase |

Experiment data shown in this table reveal that under a similar condition, the dehulled samples will have a smaller particle size than the non-dehulled samples. Taking 6 grinding operations (20 s each) as an example, 90% of the particles in the soymilk for dehulled samples have a particle size of less than 432.911 μm; however, for the non-dehulled samples, 90% of the particles have a particle size of less than 644.837 μm. In such a case, roughly a 33% reduction in particle sizes is achieved.

Additionally, Table 2 shows another experiment result which is also obtained from the same example experiment (6 grinding operations (of 20 s each) as in Table 1. The data in the following table show the percentage of particles with a size below particular values.

TABLE 2
Comparison of dehulling and non-dehulling treatment

| | |
|---|---|
| Dehulling Treatment | Non-dehulling Treatment |

| Particle size | | Particle size | Vol. |
|---|---|---|---|
| (μm) | Vol. under % | (μm) | under % |
| 67.355 | 13.28 | 67.355 | 9.94 |
| 74.884 | 13.39 | 74.884 | 10.26 |
| 83.255 | 13.50 | 83.255 | 10.58 |
| 92.562 | 13.74 | 92.562 | 10.92 |
| 102.909 | 14.23 | 102.909 | 11.30 |
| 114.413 | 15.16 | 114.413 | 11.80 |
| 127.202 | 16.73 | 127.202 | 12.49 |
| 141.421 | 19.12 | 141.421 | 13.48 |
| 157.230 | 22.52 | 157.230 | 14.91 |
| 174.806 | 27.03 | 174.806 | 16.91 |
| 194.347 | 32.68 | 194.347 | 19.61 |
| 216.071 | 39.39 | 216.071 | 23.12 |
| 240.225 | 47.00 | 240.225 | 27.51 |
| 267.078 | 55.23 | 267.078 | 32.80 |
| 296.933 | 63.72 | 296.933 | 38.93 |
| 330.126 | 72.07 | 330.126 | 45.78 |
| 367.029 | 79.85 | 367.029 | 53.16 |

Table 2 shows that for the dehulling treatment, 79.85% by volume of the particles have a particle size below 367.029 μm, whereas for the non-dehulling treatment, only 53.16% by volume of the particles have a particle size below 367.029 μm. Therefore, if we use a 50-mesh filter (corresponding to a filter with a mesh of about 355 μm, which is recommended to be used for quality inspections of commercially available soymilk makers) to filter the soymilk, for the dehulling treatment, about 79.85% by volume will pass through the 50 mesh filter, whereas for the non-dehulling treatment, only about 53.16% by volume can pass the 50-mesh filter. That is to say, with the present application, an approximately 50% residue reduction will be achieved.

As will be apparent from the above description, with the present invention, the beans can be dehulled before the blending process for soymilk-making, and therefore the size of the particles contained in the soymilk and hence the quantity of the residue are substantially reduced.

It should be noted that the use of the verb “comprise” and its conjugations does not exclude the presence of any other elements besides those defined in any claim. Additionally, it is obvious that the word “a” or “an” preceding an element does not exclude the presence of a plurality of such elements.

Although the present invention has been described with reference to the embodiments presently considered, it is to be understood that the invention is not limited to the disclosed embodiments. On the contrary, the invention is intended to cover various modifications and equivalent arrangements falling within the spirit and scope of the appended claims. The scope of the claims is to be accorded with the broadest interpretation so as to encompass all such modifications and equivalent structures and functions.

1. A device for dehulling beans, comprising:
a driving motor;
a controller electrically coupled to the driving motor for controlling the driving motor; and
a first unit coupled to and driven by the driving motor to stir the beans soaked in water so as to generate a mixture containing hulls and dehulled beans the first unit having at least one blade or at least one stirring rod stirs the beans at a stirring speed lower than 1000 rpm.

2. (canceled)

3. (canceled)

4. (canceled)

5. (canceled)

6. The device according to claim 1, wherein the stirring speed is about 400 rpm.

7. The device according to claim 1, further comprising:
a second unit for separating at least part of the hulls from the mixture.

8. An apparatus for making soymilk, comprising the device for dehulling beans according to claim 1, wherein the controller is configured to further control the driving motor so that the first unit is driven to blend the mixture at a blending speed higher than the stirring speed so as to make soymilk.

9. A method of dehulling beans, comprising:
soaking the beans in water; and
driving a first unit for stirring the soaked beans so as to generate a mixture containing hulls and dehulled beans, the first unit for stirring the soaked beans has at least one blade or at least one stirring rod, the stirring speed is lower than 1000 rpm.

10. (canceled)

11. The method according to claim 9, wherein the beans are soybeans, and the step of soaking comprising:
soaking soybeans in water at temperature between 45 to 90° C. for about 5 to 15 minutes.

12. (canceled)

13. (canceled)

14. The method according to claim 9, further comprising:
separating at least part of the hulls from the mixture.

15. A method of making soymilk, comprising:
dehulling the beans according to the method as claimed in claim 9; and
blending, by the first unit, the mixture at a blending speed higher than the stirring speed so as to make soymilk.
